(19) United States
(12) Patent Application Publication
(10) Pub. No.: US 2004/0131780 A1
(43) Pub. Date: Jul. 8, 2004

(54) Method of pattern transfer to an automobile part and an apparatus for pattern transfer to an automobile part

(76) Inventors: Masao Kamata, Tokushima (JP); Toshio Uka, Kami-gun (JP); Shinichi Kishida, Komatsushima (JP)

Correspondence Address: WENDEROTH, LIND & PONACK, L.L.P., 2033 K STREET N. W., SUITE 800, WASHINGTON, DC, 20006-1021, US

(21) Appl. No.: 10/703,572

(22) Filed: Nov. 10, 2003

(30) Foreign Application Priority Data
Nov. 12, 2002 (JP) 328825/2002

(51) Int. Cl. B05D 3/12; B05D 5/00; B05C 1/00

(52) U.S. Cl. 427/280; 427/359; 118/244

(57) ABSTRACT

The method of pattern transfer to an automobile part transfers a pattern to a solid curved-surface automobile part, which is a steering wheel or shift knob. The pattern transfer method has a transfer process step to supply ink to depressions which form a pattern in the surface of a lithograph roller, and transfer ink supplied to lithograph roller depressions to the surface of a transfer roller; and a transfer process step to press the surface of the steering wheel or shift knob into the surface of the transfer roller, rotate the transfer roller while pressing against the steering wheel or shift knob to flexibly deform the surface of the transfer roller, and attach ink on the surface of the transfer roller to the surface of the steering wheel or shift knob.

This application is based on Application No. 328825 filed in Japan on nov. 12, 2002, the content of which is incorporated hereinto by reference.

### BACKGROUND OF THE INVENTION

This invention relates to a method and apparatus to transfer a pattern such as a wood grain pattern to the surface of an automobile part such as a steering wheel or shift knob.

In luxury automobiles, steering wheels and shift knobs made from wood are often used. In a wooden steering wheel, a metal core is buried inside wood formed in a circular shape. A steering wheel with this structure has a surface decorated by the unique beauty of the wood grain pattern of natural wood. Natural woods such as maple and walnut are used. In these and other natural woods, there are those with beautiful grain patterns and those without beautiful grain patterns. Even though the manufacturing process is the same, a steering wheel made of first class natural wood having a grain pattern of extreme beauty, and a steering wheel made of third class natural wood, have radically different value as a product. A method has been proposed to produce a first class steering wheel using third class natural wood by transferring a beautiful grain pattern to the surface of the natural wood with ink.

A method using transfer film to affix a grain pattern onto the surface of a steering wheel, and a water pressure transfer method to affix a pattern (for example refer to patent reference [1]) have been developed as techniques to realize a pattern transfer method.

Patent Reference [1]: Japanese Patent Application 2001-27790

A method which uses transfer film has the drawback that a very narrow region only several mm wide along a circular cross-section across the steering wheel cannot be patterned with a wood grain pattern. This is because a steering wheel is a circular cylinder bent into a circular shape. When wide transfer film is attached to the steering wheel, wrinkles develop on the side of the steering wheel towards its center, and the entire surface of the transfer film cannot be closely and smoothly attached without gaps. If transfer film is attached to the steering wheel with gaps, the wood grain pattern cannot be transferred with a pleasing appearance. Further, depending on the direction of light and reflections, diffraction patterns can be seen in the wood grain pattern produced by transfer film. Consequently, since the wood grain pattern is obviously not a natural wood pattern, but rather an artificially printed design, the steering wheel cannot be used as a luxury item. Further, since the wood grain pattern produced by attaching transfer film takes the form of a thin film on the surface of the steering wheel, it is difficult to show the grain pattern depth unique to natural wood, and for this reason as well the steering wheel cannot be a luxury item. Still further, since the wood grain pattern cannot be solidly attached to the surface of the steering wheel, pattern transfer cannot be accomplished in a stable fashion resulting in a pattern that cannot be removed. Consequently, this method has the drawback that a high grade steering wheel cannot be efficiently and inexpensively produced in quantity.

A water pressure transfer method floats ink in a wood grain pattern on the surface of water, and attaches that pattern to the surface of a steering wheel. Therefore, pattern quality is not degraded by wrinkles as in the case of transfer film. However, in this method as well, it is extremely difficult to attach a wood grain pattern to the surface of the steering wheel with a pleasing appearance. In addition, since the pattern takes the form of a thin film on the steering wheel surface, similar to the transfer film case, the unique depth of the natural wood grain cannot be brought out. For these reasons, a high grade steering wheel cannot be produced. Further, in this method it is even more difficult than in the transfer film method to attach a stable wood grain pattern to the surface of the steering wheel. Transfer of a wood grain pattern with a pleasing appearance and in a fashion that cannot be removed is difficult. Consequently, this method also has the drawback that a high grade steering wheel cannot be efficiently and inexpensively produced in quantity.

Still further, the greatest drawback of both the transfer film method and the water pressure transfer method is the clearly visible boundary between the region of pattern transfer and the region of no pattern transfer. When a discontinuous boundary stands out, it is clear the steering wheel is not made from natural wood with a beautiful grain pattern, and it cannot be produced as a high quality item. Furthermore, not only does the boundary between a patterned and un-patterned region stand out, but it is extremely difficult to pattern that boundary region with design having a pleasing appearance. This is a further cause of steering wheel quality degradation.

Automobile parts made of natural wood with a beautiful wood grain pattern are not limited to just steering wheels, and solid curved-surface structures such as a shift knob are also made of natural wood. Consequently, a wood grain pattern is also transferred to these types of automobile parts to produce a luxurious wood grain design in the same manner done for the steering wheel. However, pattern transfers for these types of automobile parts have the same types of drawbacks as for the steering wheel. The state of the art is that production of automobile parts with beautiful high grade patterns is extremely difficult.

The present invention was developed to solve these types of drawbacks. Thus it is a primary object of the present invention to provide a method of pattern transfer to an automobile part and an apparatus for pattern transfer to an automobile part which can produce solid curved-surface automobile parts in quantity, such as a steering wheel or shift knob, as high grade items with beautiful designs in a simple and easy manner which is also efficient and inexpensive.

The above and further objects and features of the invention will more fully be apparent from the following detailed description with accompanying drawings.

### SUMMARY OF THE INVENTION

The method of pattern transfer to an automobile part of the present invention is a technique to transfer a design to a steering wheel, which is a solid curved surface automobile part. The transfer method has a transfer process step to supply ink to pattern forming depressions provided on the surface of a lithograph roller, and to transfer ink in the depressions of the lithograph roller to the surface of a transfer roller; and a transfer process step to press the steering wheel surface against the transfer roller, to rotate the steering wheel while pressing it against the transfer roller to deform the transfer roller surface in a flexible manner, and to attach the ink on the transfer roller surface to the surface of the steering wheel.

In addition, the method of pattern transfer to an automobile part of the present invention is suitable for transferring a design to a shift knob, which is also a solid curved-surface automobile part. The transfer method has a transfer process step to supply ink to pattern forming depressions provided on the surface of a lithograph roller, and to transfer ink in the depressions of the lithograph roller to the surface of a transfer roller; and a transfer process step to press the shift knob surface against the transfer roller, to rotate the shift knob while pressing it against the transfer roller to deform the transfer roller surface in a flexible manner, and to attach the ink on the transfer roller surface to the surface of the shift knob.

In the transfer method of the present invention, the transferred design can be a wood grain pattern. The transfer method of the present invention allows transfer of transfer roller ink to the steering wheel or shift knob by rotating both the steering wheel and the transfer roller or both the shift knob and the transfer roller. The transfer method of the present invention also allows direct transfer of ink from the lithograph roller to the transfer roller by rotating the lithograph roller and transfer roller with their surfaces in contact.

The apparatus for pattern transfer to an automobile part of the present invention is provided with a lithograph roller disposed in a manner allowing rotation and with depressions which establish a pattern on the roller surface, an ink supply section which supplies ink to the depressions in the lithograph roller, a transfer roller with a surface which receives ink supplied to the depressions in the lithograph roller and with a surface which can flexibly deform and serve as a flexible surface element, a press mechanism which presses a solid curved-surface automobile part such as a steering wheel or shift knob against the flexible surface element of the transfer roller and which deforms the transfer roller flexible surface element with the automobile part, and a rotation mechanism to rotate the transfer roller along the surface of the automobile part. This apparatus for pattern transfer presses the solid curved-surface automobile part against the transfer roller flexible surface element via the rotation mechanism, resiliently deforms the flexible surface element of the transfer roller with the automobile part, puts a prescribed area of the solid curved-surface automobile part in intimate contact with the flexible surface element of the transfer roller, and transfers ink on the surface of the transfer roller to the surface of the automobile part.

The ink supply section is provided with a supply roller which is rotated in contact the surface of the lithograph roller, and an ink tank which contacts one part of the supply roller and holds ink. The ink supply section can rotate the supply roller to supply ink from the ink tank to depressions in the lithograph roller.

In addition, the ink supply section can be provided with a squeegee blade in contact with the surface of the lithograph roller to scrape ink off the surface of the roller, and an ink tank that holds ink in contacts one part of the lithograph roller. In addition to supplying ink from the ink tank to the surface of the rotating lithograph roller, the ink supply section can scrape ink off the lithograph roller with the squeegee blade to supply ink only to depressions in the surface of the lithograph roller.

The apparatus for pattern transfer of the present invention can also be provided with a restraining roller to press the automobile part, assumed to be a steering wheel in this case, against the transfer roller. In this apparatus for pattern transfer, the restraining roller can rotate along the steering wheel while pressing the steering wheel against the transfer roller.

The method and apparatus described above have the characteristic that a beautiful design such as a wood grain pattern can be simply and easily transferred to the surface of a solid curved-surface automobile part such as a steering wheel or shift knob in an extremely efficient manner, and high grade automobile parts can be produced inexpensively in quantity. Specifically, a pattern is transferred to the surface of a transfer roller having a flexible surface element, a steering wheel or shift knob is pressed into the surface of the transfer roller to flexibly deform that surface, and under those conditions, the transfer roller is rotated along the surface of the automobile part. Therefore, a beautiful design can be transferred efficiently to a wide area of the surface of the automobile part, and in particular, this method and apparatus have the superior characteristic that the boundary between regions of pattern transfer and regions of no pattern transfer can be made indistinct and not obvious. Consequently, when a wood grain pattern is transferred to an automobile part in this fashion, a natural pattern can result which essentially cannot be distinguished from high grade natural wood. Further, by pressing the automobile part into the surface of the transfer roller and resiliently deforming the flexible surface element of the transfer roller, the pattern is transferred with the transfer roller and surface of the automobile part in intimate contact. This has the characteristic that the pattern can be transferred in a stable fashion with a pleasing appearance. Further, since the pattern is transferred while pressing the automobile part into the transfer roller, ink can be transferred deeply into the automobile part and is not easily removed. Therefore, in addition to allowing simple efficient final processing of a pattern transferred automobile part, this method and apparatus have the characteristic that a high grade pattern with the depth of natural wood can be transferred to the surface of the automobile part.

### BRIEF DESCRIPTION OF THE DRAWINGS

FIG. 1 is a front view partially in cross-section of an apparatus for pattern transfer to an automobile part as an embodiment of the present invention.

FIG. 2 is a side view partially in cross-section of the apparatus for pattern transfer to an automobile part shown in FIG. 1.

FIG. 3 is a front view partially in cross-section of another embodiment of an apparatus for pattern transfer to an automobile part of the present invention.

FIG. 4 is an abbreviated view showing a shift knob pressed into a transfer roller.

### DETAILED DESCRIPTION OF THE INVENTION

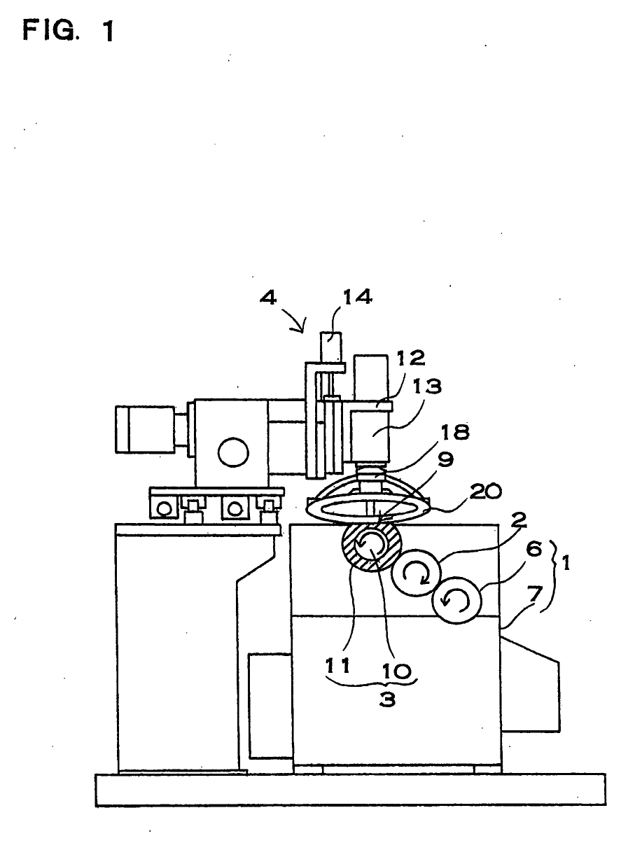

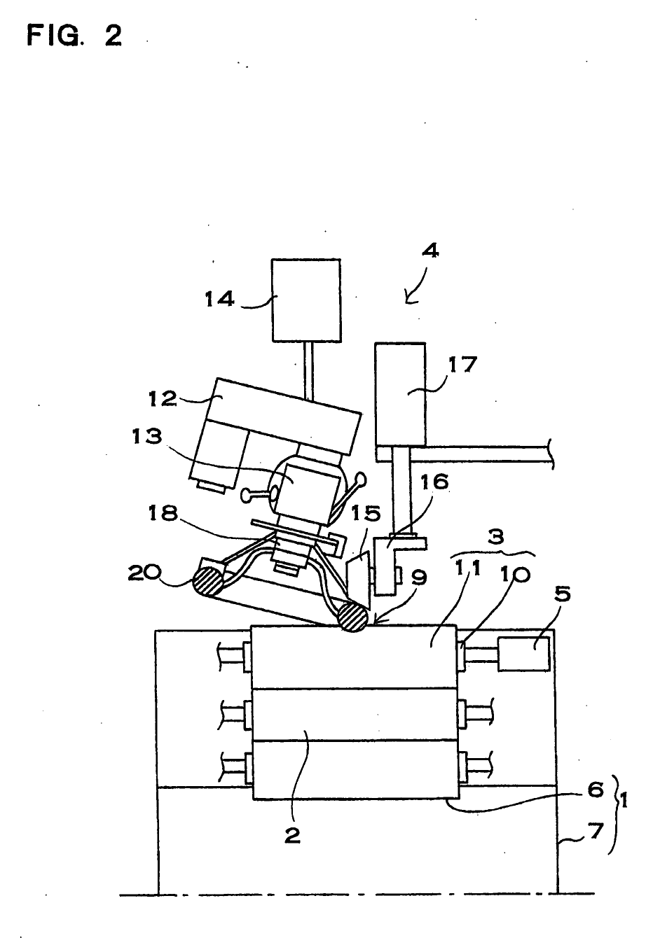

Turning to FIGS. 1 and 2, an apparatus for pattern transfer to an automobile part, which is a steering wheel, is shown. However, the apparatus for pattern transfer shown in the figures can transfer a pattern to any solid curved-surface automobile part as well as to a steering wheel. The pattern transferred to the surface of an automobile part is, for example, the wood grain pattern of a wood like maple or walnut. However, it is obvious a pattern or design other than a wood grain pattern can also be transferred. Raw material for an automobile part for pattern transfer is primarily wood. Woods like maple, walnut, rosewood, bony, oak, and camphor can be used as raw material for automobile parts. By transferring the beautiful grain pattern of natural wood to the surface of wood material, an extremely high grade automobile part can be produced. In particular, by using a wood grain pattern and wood material for the automobile part of the same type of wood, very natural, high grade automobile parts such as a steering wheel or shift knob can be produced. For example, if a beautiful, high quality maple grain pattern is transferred to maple material, which is low quality because of its simple grain pattern, a natural and beautiful high quality automobile part such as a steering wheel can be produced. However, the type of material for an automobile part for pattern transfer is not limited to wood, and the raw material can also be a material such as plastic or metal. An automobile part which has had a wood grain pattern transferred to it almost without exception has its surface covered with a clear coating. Therefore, a plastic or metal automobile part, which has its surface patterned as wood grain, can approximate a beautiful external appearance comparable to natural wood.

The apparatus for pattern transfer shown in the figures is provided with a lithograph roller 2 with pattern forming depressions on its surface and disposed via bearings in a manner allowing rotation, an ink supply section 1 which supplies ink to the depressions in the lithograph roller 2, a transfer roller 3 with a surface which receives ink supplied to the depressions in the lithograph roller 2 and with a surface which can flexibly deform and serve as a flexible surface element 9, a press mechanism 4 which presses a solid curved-surface automobile part such as a steering wheel 20 or shift knob into the flexible surface element 9 of the transfer roller 3 and which deforms the transfer roller 3 flexible surface element 9 with the automobile part, and a rotation mechanism 5 to rotate the transfer roller 3 along the surface of the automobile part. This apparatus for pattern transfer presses the solid curved-surface automobile part against the transfer roller 3 flexible surface element 9 via the rotation mechanism 5, resiliently deforms the flexible surface element 9 of the transfer roller 3 with the automobile part, puts a prescribed area of the solid curved-surface automobile part in intimate contact with the flexible surface element 9 of the transfer roller 3, and transfers ink on the surface of the transfer roller 3 to the surface of the automobile part.

The shape of the depressions provided in the surface of the lithograph roller 2 determines the pattern transferred to the surface of the automobile part. This is because ink filling the depressions in the surface of the lithograph roller 2 is transferred to the surface of the automobile part to create the pattern. Consequently, depressions are established in the desired pattern in the surface of the lithograph roller 2. By making depressions deep for dark regions and shallow for light regions, a pattern with light and dark tones can be transferred to the surface of an automobile part. The surface of the lithograph roller 2 is provided with depressions shaped to form the grain pattern of natural wood. Grain patterns of natural wood have striped patterns of parallel winter and summer growth rings, and locally interspersed knot patterns. Irregular complex natural wood grain patterns are generally regarded more beautiful than simple patterns. In particular, natural wood such as maple with many knot patterns interspersed irregularly is considered high grade, and its grain pattern is actually quite beautiful. Consequently, using maple with a simple grain pattern as raw material for an automobile part, and transferring complex knot patterns onto the surface of that maple allows it to be made into a very high grade steering wheel or other automobile part. When the natural striped grain pattern of the maple itself is used and knot patterns are transferred, it becomes essentially indistinguishable from high grade maple, and a very high quality steering wheel or other automobile part can be produced. This technique is not limited to maple. For example, low grade walnut can be used as raw material, and a very high quality steering wheel or other automobile part can be realized by transferring a high grade walnut grain pattern to the low grade walnut.

In addition, using natural wood with an extremely simple grain pattern as raw material, and transferring a high grade natural wood pattern including both winter and summer growth ring stripes as well as knot patterns also allows production of a high quality steering wheel or other automobile part. The lithograph roller 2 used for production of this automobile part has depressions which establish both stripe and knot patterns in the roller surface. The lithograph roller 2 is a metal roller with depressions, which can be established in the form of the pattern by etching the smoothly finished surface of the roller, or which can be carved with bladed tools out of the roller surface to establish the pattern.

The ink supply section 1 supplies ink to the depressions in the lithograph roller 2. The ink supply section 1 of the apparatus shown in FIG. 1 is provided with a supply roller 6 which rotates in contact with the lithograph roller 2, and an ink tank 7 which stores ink that contacts one part of the supply roller 6. In this ink supply section 1, the supply roller 6 is rotated to supply ink from the ink tank 7 to depressions in the lithograph roller 2. As shown in FIG. 1, when the supply roller 6 is rotated, ink attaches to the surface of the supply roller 6. The surfaces of the lithograph roller 2 and the supply roller 6 are in contact and they rotate in opposite directions. Ink attached to the surface of the supply roller 6 is transferred to the lithograph roller 2. Since the lithograph roller 2 and the supply roller 6 are in mutual contact and rotate together in opposite directions, excess ink, or ink in regions other than the depressions, is removed from the lithograph roller 2 with the passage of the supply roller 6. Consequently, after passage of the supply roller 6, ink supplied to the lithograph roller 2 remains only in the depressions.

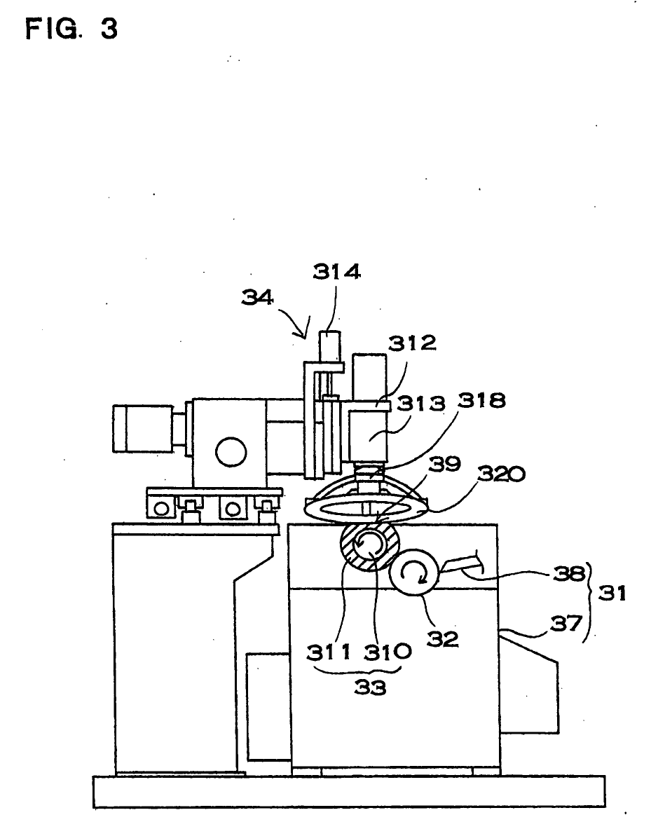

In this invention, the ink supply section 1, which supplies ink to the depressions in the lithograph roller 2, is not limited to the structure shown in FIG. 1. The configuration of the ink supply section can be any structure that supplies ink to the depressions in the lithograph roller. The ink supply section 31 of FIG. 3 is provided with a squeegee blade 38 in contact with the surface of the lithograph roller 32 to scrape ink off the surface of the roller, and an ink tank 37 which holds ink that contacts one part of the lithograph roller 32. In this ink supply section 31, the lithograph roller 32 is rotated in a position to contact ink in the ink tank 37, which attaches to the surface of the lithograph roller 32. Ink attached to the surface of the lithograph roller 32 is scraped off by the squeegee blade 38. Since ink supplied to depressions in the lithograph roller 32 is not scraped off by the squeegee blade 38, ink is supplied only to the depressions. In the embodiment of FIG. 3, structural elements which are the same as the embodiment shown in FIGS. 1 and 2 are designated by the same part number except for the highest order digit, and their explanation is abbreviated.

The transfer roller 3 has a rotation shaft 10 affixed with a resilient elastic material 11 to establish the flexible surface element 9. The flexible surface element 9 of resilient elastic material 11 has pliability to flexibly deform when an automobile part such as a steering wheel 20 or shift knob is pressed into its surface. Relatively hard rubber is used as the resilient elastic material 11. An automobile part such as a steering wheel is pressed into the surface of the transfer roller 3 with a force of several Kg to several tens of Kg. Consequently, the automobile part such as a steering wheel can contact and embed into the surface of the transfer roller 3 using relatively hard rubber as the resilient elastic material 11. By providing pliability to the flexible surface element 9, a pattern can be transferred to a wide area of a solid curved-surface automobile part. However, since stable transfer of a pattern with pleasing appearance becomes difficult if the flexible surface element 9 is too soft, suitable hardness of the flexible surface element 9 resilient elastic material 11 is selected considering the pressing force of the automobile part, the area for pattern transfer, and the ability to transfer a stable pattern with pleasing appearance.

The press mechanism 4 presses the automobile part such as a steering wheel 20 into the surface of the transfer roller 3. The press mechanism 4 of the figures is provided with a pressure cylinder 14 that raises and lowers a vertically moving mount 12 to which a rotation motor 13 is fixed to rotate the automobile part. The pressure cylinder 14 raises and lowers the vertically moving mount 12 to press the automobile part into the transfer roller 3. The pressure cylinder 14 is a hydraulic or pneumatic cylinder. The pressure supplied to the pressure cylinder 14 is adjusted to regulate the pressing force of the automobile part into the transfer roller 3. Although the force exerted by the pressure cylinder to press the automobile part into the transfer roller 3 is not fixed depending on the shape of the automobile part, for example, for the case of a steering wheel, it is from about 5 to 40 Kg, preferably from 10 to 30 Kg, and more preferably about 20 Kg. The case of a shift knob is similar to that of a steering wheel in that force is applied to the shift knob to press it into the transfer roller 3.

In the press mechanism 4 of the figures (FIG. 2), a restraining roller 15 may be provided to press the automobile part, which is a steering wheel 20, against the transfer roller 3. The restraining roller 15 is disposed in a position above the part of the steering wheel 20 being pressed into the surface of the transfer roller 3, and the restraining roller 15 presses that part of the steering wheel 20 towards the surface of the transfer roller 3. The restraining roller 15 is connected via a vertically moving mount 16 to a cylinder 17, and is raised and lowered by the cylinder 17 to press the automobile part, which is a steering wheel 20, against the transfer roller 3. The restraining roller 15 is connected to the vertically moving mount 16 in a manner that allows it to rotate while pressing against the steering wheel 20. In this pattern transfer apparatus, the transfer roller 3 rotates along the steering wheel 20 while the restraining roller 15 presses the steering wheel 20 into the transfer roller 3. This configuration, which locally presses an automobile part such as a steering wheel 20 into the transfer roller 3 via a restraining roller 15, has the characteristic that the automobile part can be reliably pressed into the surface of the transfer roller 3 to precisely deform the surface of the transfer roller 3 in a resilient fashion.

The rotation mechanism 5 rotates the transfer roller 3 to move the transfer roller 3 along the surface of the automobile part. The rotation mechanism 5 is a motor (not illustrated) which connects to the rotation shaft 10 of the transfer roller 3. However, the rotation mechanism 5 does not have to directly rotate the transfer roller 3, and may also drive the transfer roller 3 by rotating the lithograph roller 2. In this type of apparatus, the lithograph roller 2 is rotated by a motor (not illustrated), and the transfer rollor 3 is put in contact with the lithograph roller 2 to rotate the transfer roller 3. In any case, the supply roller 6, the lithograph roller 2, and the transfer roller 3 of the pattern transfer apparatus preferably rotate in mutual contact at a speed that produces no slippage

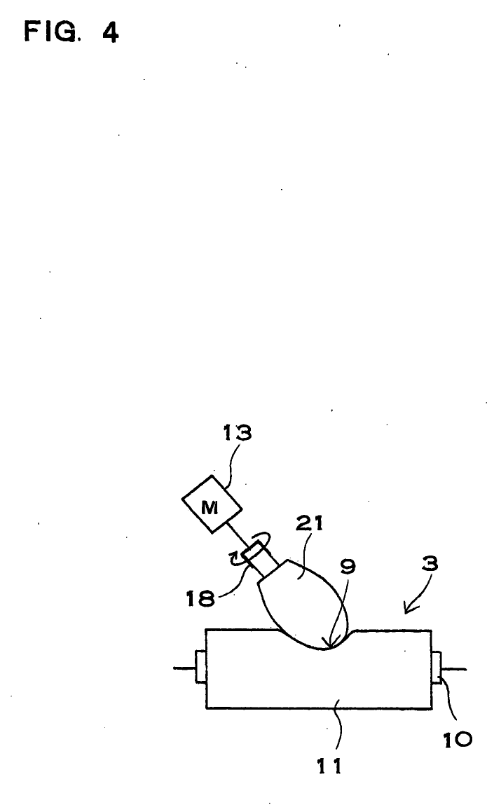

The pattern transfer apparatus of the figures is provided with a rotation motor 13 to rotate the automobile part itself, which is a steering wheel. The rotation motor 13 is a stepping motor which rotates the steering wheel 20 at a rate synchronous with the transfer roller 3. This serves to rotate the surfaces of the steering wheel and the transfer roller with no slippage. The rotation motor 13 is provided with a mounting section 18 at the end of its output shaft to mount the hub of the steering wheel 20 in a detachable manner. The rotation motor 13 of the figures rotates the steering wheel 20 while pressing it into the transfer roller 3 with an inclined orientation. The rotation motor 13 is fixed to a vertically moving mount 12. When the vertically moving mount 12 of the press mechanism 4 is pressed towards the transfer roller 3, the rotation motor 13 rotates the steering wheel 20, which is pressed into the transfer roller 3. Although the figures show a steering wheel 20 being pressed into the transfer roller 3, a shift knob 21, as shown in FIG. 4, can also be pressed into a transfer roller 3 while rotating it with a rotation motor 13 to transfer a pattern. This rotation motor 13 is provided with a mounting section 18 at the end of its output shaft to mount the shift knob 21 in a detachable manner.

The pattern transfer apparatus described above transfers a pattern to the surface of a solid curved-surface automobile part such as a steering wheel 20 or shift knob 21 by the following process steps. Ink is applied to the surface of an automobile part to transfer a pattern or design by transfer process steps (1) and (2) below. However, process steps (1) and (2) can be performed simultaneously and continuously to transfer a pattern to an automobile part,

(1) Transfer Process Step

The supply roller 6, lithograph roller 2, and transfer roller 3 are rotated synchronously with no slippage. Ink from the ink tank 7 attaches to the surface of the supply roller 6, and is supplied to depressions in the lithograph roller 2. Ink supplied to the depressions in the lithograph roller 2 is transferred from lithograph roller 2 depressions to the transfer roller. 3.

(2) Transfer Process Step

The surface of an automobile part such as a steering wheel 20 or shift knob 21 is pressed into the surface of the transfer roller 3, and the transfer roller 3 is rotated while pressing the automobile part to resiliently deform the surface of the transfer roller 3. In this configuration, ink attached to the surface of the transfer roller 3 is transferred to the surface of the automobile part such as a steering wheel 20 or shift knob 21.

In the apparatus and method described above, surfaces of the lithograph roller 2 and transfer roller 3 are rotated while in contact, and ink is transferred directly from the lithograph roller 2 to the transfer roller 3. However, one or a plurality of intermediate rollers may also be provided between the lithograph roller and transfer roller, and the intermediate rollers, lithograph roller, and transfer roller can be rotated in contact to transfer lithograph roller ink to the transfer roller via the intermediate rollers.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within the metes and bounds of the claims or equivalence of such metes and bounds thereof are therefore intended to be embraced by the claims.

What I claimed is:

1. A method of pattern transfer to an automobile part that transfers a pattern to the surface of a steering wheel which is a solid curved-surface automobile part having:
a transfer process step to supply ink to depressions which establish a pattern in the surface of a lithograph roller, and transfer the ink supplied to lithograph roller depressions to the surface of a transfer roller; and a transfer process step to press the surface of the steering wheel into the surface of the transfer roller, rotate the transfer roller while pressing against the steering wheel and flexibly deforming the surface of the transfer roller, and attach ink adhered to the surface of the transfer roller to the surface of the steering wheel.

2. A method of pattern transfer to an automobile part as recited in claim 1 wherein the raw material to form the steering wheel is plastic.

3. A method of pattern transfer to an automobile part as recited in claim 1 wherein the raw material to form the steering wheel is wood.

4. A method of pattern transfer to an automobile part as recited in claim 1 wherein the pattern is a wood grain pattern.

5. A method of pattern transfer to an automobile part as recited in claim 4 wherein the raw material and the wood grain pattern are of the same type of wood.

6. A method of pattern transfer to an automobile part as recited in claim 5 wherein the raw material is maple and the wood grain pattern is a maple grain pattern.

7. A method of pattern transfer to an automobile part as recited in claim 6 wherein the maple wood grain pattern is a natural wood grain pattern including both striped summer and winter growth patterns and knot patterns.

8. A method of pattern transfer to an automobile part as recited in claim 5 wherein the raw material is walnut and the wood grain pattern is a walnut grain pattern.

9. A method of pattern transfer to an automobile part as recited in claim 1 wherein the steering wheel is pressed by a restraining roller, and the steering wheel is pressed into the transfer roller.

10. A method of pattern transfer to an automobile part as recited in claim 1 wherein both the steering wheel and the transfer roller are rotated, and transfer roller ink is transferred to the steering wheel.

11. A method of pattern transfer to an automobile part as recited in claim 1 wherein the lithograph roller and the transfer roller are rotated with their surfaces in contact, and ink is directly transferred from the lithograph roller to the transfer roller.

12. A method of pattern transfer to an automobile part that transfers a pattern to the surface of a shift knob which is a solid curved-surface automobile part having:
a transfer process step to supply ink to depressions which establish a pattern in the surface of a lithograph roller, and transfer the ink supplied to lithograph roller depressions to the surface of a transfer roller; and a transfer process step to press the surface of the shift knob into the surface of the transfer roller, rotate the transfer roller while pressing against the shift knob and flexibly deforming the surface of the transfer roller, and attach ink adhered to the surface of the transfer roller to the surface of the shift knob.

13. A method of pattern transfer to an automobile part as recited in claim 12 wherein the raw material to form the shift knob is plastic.

14. A method of pattern transfer to an automobile part as recited in claim 12 wherein the raw material to form the shift knob is wood.

15. A method of pattern transfer to an automobile part as recited in claim 12 wherein the pattern is a wood grain pattern.

16. A method of pattern transfer to an automobile part as recited in claim 15 wherein the raw material and the wood grain pattern are of the same type of wood.

17. A method of pattern transfer to an automobile part as recited in claim 16 wherein the raw material is maple and the wood grain pattern is a maple grain pattern.

18. A method of pattern transfer to an automobile part as recited in claim 17 wherein the maple wood grain pattern is a natural wood grain pattern including both striped summer and winter growth patterns and knot patterns.

19. A method of pattern transfer to an automobile part as recited in claim 16 wherein the raw material is walnut and the wood grain pattern is a walnut grain pattern.

20. A method of pattern transfer to an automobile part as recited in claim 12 wherein both the shift knob and the transfer roller are rotated, and transfer roller ink is transferred to the shift knob.

21. A method of pattern transfer to an automobile part as recited in claim 12 wherein the lithograph roller and the transfer roller are rotated with their surfaces in contact, and ink is directly transferred from the lithograph roller to the transfer roller.

22. An apparatus for pattern transfer to an automobile part comprising a lithograph roller provided with depressions which form a pattern on its surface and disposed in a fashion allowing rotation, an ink supply section which supplies ink to the depressions in the lithograph roller, a transfer roller with a flexible surface element that can resiliently deform and serve as a surface for transfer of ink supplied to the depressions in the lithograph roller, a press mechanism which presses a solid curved-surface automobile part such as a steering wheel or shift knob into the flexible surface element of the transfer roller and resiliently deforms the flexible surface element with the automobile part, and a rotation mechanism which rotates the transfer roller along the surface of the automobile part;
wherein the press mechanism presses the solid curved-surface automobile part into the flexible surface element of the transfer roller, the flexible surface element of the transfer roller is resiliently deformed by the automobile part, a prescribed area of the solid curved-surface automobile part makes intimate contact with the flexible surface element of the transfer roller, and ink attached to the surface of the transfer roller is transferred to the surface of the automobile part.

23. An apparatus for pattern transfer to an automobile part as recited in claim 22 wherein the ink supply section which supplies ink to the depressions in the lithograph roller is provided with a supply roller which rotates in contact with the surface of the lithograph roller, and an ink tank which stores ink that contacts one part of the supply roller, and wherein the supply roller is rotated and ink from the ink tank is supplied to the depressions in the lithograph roller.

24. An apparatus for pattern transfer to an automobile part as recited in claim 22 wherein the ink supply section which supplies ink to the depressions in the lithograph roller is provided with a squeegee blade which contacts the surface of the lithograph roller and scrapes off ink attached to the surface of the lithograph roller, and an ink tank which stores ink that contacts one part of the lithograph roller, and wherein the lithograph roller is rotated and ink from the ink tank attaches to the surface of the lithograph roller and adhered ink is scraped off by the squeegee blade to supply ink only to the depressions.

25. An apparatus for pattern transfer to an automobile part as recited in claim 22 wherein the automobile part is a steering wheel and a restraining roller is provided which presses the steering wheel into the transfer roller, and wherein the transfer roller is rotated along the steering wheel while the restraining roller presses the steering wheel into the transfer roller.

26. An apparatus for pattern transfer to an automobile part as recited in claim 22 wherein the automobile part is a steering wheel.

27. An apparatus for pattern transfer to an automobile part as recited in claim 22 wherein the automobile part is a shift knob.

28. An apparatus for pattern transfer to an automobile part as recited in claim 26 wherein the raw material to form the steering wheel is plastic.

29. An apparatus for pattern transfer to an automobile part as recited in claim 27 wherein the raw material to form the shift knob is plastic.

30. An apparatus for pattern transfer to an automobile part as recited in claim 26 wherein the raw material to form the steering wheel is wood.

31. An apparatus for pattern transfer to an automobile part as recited in claim 27 wherein the raw material to form the shift knob is wood.

32. An apparatus for pattern transfer to an automobile part as recited in claim 22 wherein the pattern is a wood grain pattern.

33. An apparatus for pattern transfer to an automobile part as recited in claim 32 wherein the raw material and the wood grain pattern are of the same type of wood.

34. An apparatus for pattern transfer to an automobile part as recited in claim 33 wherein the raw material is maple and the wood grain pattern is a maple grain pattern.

35. An apparatus for pattern transfer to an automobile part as recited in claim 34 wherein the maple wood grain pattern is a natural wood grain pattern including both striped summer and winter growth patterns and knot patterns.

36. An apparatus for pattern transfer to an automobile part as recited in claim 33 wherein the raw material is walnut and the wood grain pattern is a walnut grain pattern.

37. An apparatus for pattern transfer to an automobile part as recited in claim 22 wherein the steering wheel is pressed by a restraining roller, and the steering wheel is pressed into the transfer roller.
